(19) United States
(12) Patent Application Publication
(10) Pub. No.: US 2010/0083444 A1
(43) Pub. Date: Apr. 8, 2010

(54) LAUNDRY DETERGENT COMPOSITIONS AND USES THEROF

(76) Inventor: Julia Fry, Berkeley, CA (US)

Correspondence Address: MINTZ, LEVIN, COHN, FERRIS, GLOVSKY AND POPEO, P.C, One Financial Center, BOSTON, MA, 02111, US

(21) Appl. No.: 12/554,563

(22) Filed: Sep. 4, 2009

Related U.S. Application Data
(60) Provisional application No. 61/095,302, filed on Sep. 8, 2008.

(51) Int. Cl. C11D 3/20

(52) U.S. Cl. 8/137; 510/327; 510/328

(57) ABSTRACT

The invention relates generally to novel laundry detergent compositions comprising linalol and uses thereof. Aspects of the invention include a laundry detergent that includes an effective amount of linalol, which has not been modified to provide a fragrance, for improving color retention and fabric softening qualities and reducing soap residue retention and static electricity.

### CROSS-REFERENCE TO RELATED APPLICATIONS

This application claims the benefit of U.S. Provisional Application No. 61/095,302, filed Sep. 8, 2008, which application is incorporated herein by reference in its entirety.

### TECHNICAL FIELD

The disclosure relates to laundry detergent compositions comprising linalol and uses thereof.

### BACKGROUND OF THE INVENTION

Traditional laundry detergent is a composition that when added to fabrics during washes, function to help physically remove dirt, soil, and stains from the textile surfaces being cleaned. Laundry detergent compositions come in both liquid and powder forms and in general, are comprised of blends of anionic and nonionic surfactants with any number of ingredients being added in order to improve cleaning performance. Often, laundry detergent compositions include a number of fragrances that include linalol for example which impart a pleasant aromatic odor to the washed textiles.

Fragrance compounds are highly volatile substances that require stabilization to prevent them from rapidly evaporating. Fragrances in laundry compositions should evaporate in a controlled manner to effect a long lasting and constant fragrant effect which not only lasts throughout the laundry process but remains on the textiles after the drying process.

The chemistry and technology of formulating a fragrance for detergents is well developed. Various petroleum additives need to be added to the fragrance compound to retard the evaporation rate of the fragrance. For example, fragrances may be deposited on carrier materials, encapsulated or embedded in compounds in order to achieve a controlled release. Fragrances that are not further modified to include petroleum additives are incapable of leaving a fragrance on textiles after the washing process because the fragrance would have evaporated during the washing cycle.

In general, because fragrances are not considered to be an active agent that contribute to the washing process, laundry compositions only include a small amount of processed fragrance that is only sufficient for imparting the pleasant aromatic odor on to the washed textiles.

Recently, there has been a major focus on producing laundry compositions that are natural and eco-friendly. Many environmental organizations consider a fragrance to be an unnecessary and unhealthy component to a detergent because the petroleum additives needed to prevent the evaporation of fragrances are not biodegradable and are considered to be unhealthy when in close proximity to a person's skin. Accordingly, there is a continued interest in the development of laundry detergent compositions that not only clean fabrics but are also friendly to the environment. It is especially desirable to develop laundry detergent compositions using non-fragrant, natural products that improve the qualities/properties of the detergent.

### SUMMARY OF THE INVENTION

The subject matter disclosed herein relates to laundry detergent compositions comprising linalol and uses thereof.

As summarized above, the laundry detergent compositions of the present invention include an effective amount of linalol which conditions the fabric and helps to remove detergent residue. Aspects of the invention incorporate linalol into the laundry detergent which functions as a fabric conditioning agent that reduces detergent residue from the fabric. In certain aspects, the effective amount of linalol is provided in its natural form while in other aspects, the compositions include a synthetic linalol.

In general, laundry detergents often add fragrance agents to deliver a fresh or clean odor to textiles. In these detergents, the fragrance agents have been altered to control the evaporation rate so that a pleasant smell may remain on the fabrics after washing. For example, often times the fragrance agent is provided in an encapsulation system to protect and release the fragrance in a controlled manner. This is very different from the linalol provided in the present application.

The linalol employed in the present compositions do not have a fragrance and have not been altered or provided in a formulation which controls the evaporation rate. The present compositions include linalol in a formulation which gets absorbed onto the fabric being washed and which does not function as a fragrance agent added to the fabric. The absorbed linalol according to the compositions and methods described herein condition the fabric to be softer and helps to reduce the amount of detergent residue on the fabric.

In certain aspects, provided is an unscented laundry detergent composition that includes an effective amount of linalol, wherein the linalol is effective for conditioning a fabric during a washing program. The effective amount of linalol may range from 0.004 to 0.012%. In other aspects, the effective amount of linalol is 0.012%. In certain aspects, the linalol may be natural linalol and in other aspects, the linalol is a synthetic linalol.

In certain aspects, provided is an unscented laundry detergent composition that includes an effective amount of an essential oil comprising 30% or more of linalol, wherein the essential oil has not been formulated to impart a fragrance and wherein the amount of linalol in the essential oil is effective for conditioning a fabric during a washing program. The effective amount of an essential oil comprising linalol may range from 0.1 to 0.3%. In other aspects, the effective amount of an essential oil that comprises linalol is 0.2%.

In other aspects, the effective concentration of linalol in the laundry detergents may range from 0.008 to 0.015 grams. In certain instances, the effective concentration may be 0.008 g, 0.009 g, 0.01 g, 0.011 g, 0.012 g, 0.013 g, 0.014 g, or 0.015 g. In another aspect, the effective concentration of linalol may be 0.012 g.

The laundry detergent composition may have an effective concentration of an essential oil ranging from 0.02 g to 0.05 g. In other aspects, the essential oil may have an effective concentration of 0.03 g. In another aspect, the essential oil may be lavender oil.

In some aspects, the laundry detergent conditions fabrics during a washing process. In another aspect, the washed fabrics are softer than fabrics washed with a detergent without linalol or a detergent that includes an essential oil comprising less than 30% linalol.

In another aspect, the detergent composition reduces soap residue on washed fabrics as compared to fabrics washed with a detergent without linalol or a detergent that includes an essential oil comprising less than 30% linalol.

In another aspect, the detergent composition improves color retention of washed fabrics as compared to fabrics washed with a detergent without linalol or a detergent that includes an essential oil comprising less than 30% linalol.

In another aspect, the detergent composition reduces static electricity in washed fabrics as compared to fabrics washed with a detergent without linalol or a detergent that includes an essential oil comprising less than 30% linalol.

In certain aspects, the laundry detergent composition is a powder detergent. In other aspects, the laundry detergent composition is a liquid detergent.

Aspects of the invention include a method for reducing soap residue on washed fabrics. The method includes adding an unscented detergent composition comprising an effective amount of an essential oil comprising 30% or more of linalol to fabrics. The method may further include washing the fabrics, wherein the washed fabrics are conditioned and have less detergent residue when compared to fabrics washed with a detergent without linalol or a detergent that includes an essential oil comprising less than 30%.

Aspects of the invention include an unscented laundry detergent composition comprising an effective amount of linalol ranging from 0.004% to 0.012%, wherein the linalol is effective in conditioning a fabric during a washing program. In certain aspects, the linalol is a synthetic linalol.

The laundry detergent compositions do not include linalol or an essential oil that have been deposited on a carrier material, encapsulated or embedded in compounds to control its evaporation rate during a washing and drying process.

Aspects of the invention include providing an essential oil comprising linalol in the laundry detergent compositions that do not impart a fragrance to the fabrics but instead are present for the purpose of conditioning and softening the fabrics during the washing cycle.

In another aspect, the laundry detergent compositions may further improve the removal of detergent residue. In certain instances, because the linalol is so effective in removing detergent residue, an additional rinse is not required by a user to remove the residue.

### DETAILED DESCRIPTION OF THE INVENTION

Before the present invention is described in greater detail, it is to be understood that this invention is not limited to particular embodiments described, as such may vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

It must be noted that, as used in this specification and the appended claims, the singular forms “a,” “an” and “the” include plural referents unless the context clearly dictates otherwise. Thus, for example, “an agent” refers not only to a single agent but also to a combination of two or more different agents; “a surfactant” refers to a combination of surfactant as well as to a single surfactant, and the like. Unless defined otherwise, all technical and scientific terms used herein have the meaning commonly understood by one of ordinary skill in the art to which the invention pertains. Although any methods and materials similar or equivalent to those described herein may be useful in the practice or testing of the present invention, preferred methods and materials are described below. Specific terminology of particular importance to the description of the present invention is defined below.

### Linalol

The laundry detergent compositions described herein include an effective amount of linalol (also known as linalool or 3,7-dimethyl-1,6-octadien-3-ol), which has the following structural formula.

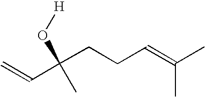

Linalol is a colorless liquid which is distilled from the essential oils of various plants, i.e., essential oils such as rosewood, bergamot, coriander, and lavender to name a few. The essential oils employed in the subject laundry detergent compositions consist of at least 30% linalol. In certain aspects, the laundry detergent compositions may include an essential oil that consists of at least 30% to 60% of linalol. For example, the laundry detergent composition may include an essential oil that consists of at least 30, 32, 34, 36, 38, 40, 42, 44, 46, 48, 50, 52, 54, 56, 58, or 60% linalol.

When an essential oil is added to a laundry detergent as a fragrance agent, the essential oil is typically fractionated to reduce the percentage of linalol. This is because linalol by itself is essentially odor free. In other words, linalol does not provide a fragrance and as such, is incapable of delivering a fresh or clean odor to textiles. Because of this, essential oils that are added to laundry detergents as a fragrance agent are typically formulated to have a lower wt. % of linalol. For example, the essential oils formulated to be added as a fragrance typically have less than 30% of linalol. This is distinguishable from the laundry detergent formulations of the present invention because the essential oils according to the present invention comprise at least 30-60% of linalol.

In laundry detergent compositions, a fragrance agent is susceptible to evaporation, reaction with other ingredients in the detergents, oxidation and chemical degradation. As such, the fragrance agent is typically provided in a formulation which is sufficient to control the rate of evaporation so that the fragrance remains on the fabrics after washing. For example, a fragrance agent may be deposited on a carrier material or get encapsulated or embedded in compounds to protect and release the fragrance in a controlled manner during the washing and drying process. Such fragrance agents in these formulations evaporate at a slower rate and impart a pleasant odor to the washed textile fabrics.

When the present laundry detergent includes an essential oil comprising linalol, the essential oil has not been altered or formulated to control its evaporation rate. As such, the essential oil does not have an altered evaporation rate and does not leave a fragrance on the fabrics after washing. In other words, although an essential oil comprising linalol may be included in the laundry detergent compositions, the essential oil has not been deposited on a carrier material, encapsulated or embedded in compounds to protect and release a fragrance in a controlled manner during a washing and drying process. As such, the essential oils comprising linalol in the laundry detergent compositions do not function as a fragrance and are essentially fragrance free.

In certain aspects, the laundry compositions include an effective amount of a linalol formulation which unexpectedly has been found to condition a fabric during washing. In other words, the present laundry compositions include an effective amount of a linalol formulation which does not impart a fragrance but instead is capable of softening and conditioning fabrics during the washing process. In certain aspects, the amount of linalol present in the laundry detergent composition is effective to better condition a fabric when compared to a laundry detergent composition that does not include a linalol formulation or one that includes an essential oil comprising less than 30% linalol. In other aspects, the amount of linalol present in the laundry detergent composition is effective to score greater than a 3.7 in softness when tested using ASTM D5237-92 (herein referred to as “ASTM”). In another aspect, the amount of linalol present in the laundry detergent composition is effective to score greater than 4.0 or more in softness when tested using ASTM. In another aspect, the amount of linalol present in the laundry detergent composition is effective to score greater than 4.3 or more in softness when tested using ASTM. In another aspect, the amount of linalol present in the laundry detergent composition is effective to score greater than 5.0 or more in softness when tested using ASTM.

After cleaning, fabrics can often feel stiff and harsh as a result of remaining detergent on the fabric. Because the laundry detergent compositions are able to condition, thereby, soften fabrics after washing, the present compositions have unexpectedly been found to improve the removal of detergent residue. As such, the laundry compositions include an effective amount of a linalol formulation which does not impart a fragrance but instead is capable of removing detergent residue during the washing process. In certain aspects, the amount of a linalol formulation present in the laundry detergent composition is effective to better remove detergent residue from a fabric when compared to a laundry detergent composition that does not include a linalol formulation or one that includes an essential oil comprising less than 30% linalol.

In an optional variation, the laundry compositions are so effective in removing detergent residue that an additional rinse step need not be performed during the washing cycle. Aspects of this variation include increasing the efficiency of water usage during the washing process and also reducing the amount of water which gets drained into the environment during the washing process.

In another aspect, the laundry compositions have unexpectedly been found to protect the colors of fabric from fading. The laundry detergent compositions may include an effective amount of a linalol formulation which does not impart a fragrance but instead protects the colors of the fabric from fading during the washing process. In certain aspects, the amount of a linalol formulation present in the laundry detergent composition is effective to better protect a fabric from fading when compared to a laundry detergent composition that does not include a linalol formulation or one that includes an essential oil comprising less than 30% linalol. In other aspects, the amount of linalol present in the laundry detergent composition is effective to score greater than a 4.7 in color retention when tested using ASTM. In another aspect, the amount of linalol present in the laundry detergent composition is effective to score 5.0 or more in color retention when tested using ASTM. In another aspect, the amount of linalol present in the laundry detergent composition is effective to score greater than 5.3 or more in color retention when tested using ASTM.

In another aspect, the laundry compositions have unexpectedly been found to reduce static electricity in fabrics. As such, the laundry detergent compositions include an effective amount of a linalol formulation which does not impart a fragrance but instead is capable of reducing the amount of static electricity generated during the washing process. In certain aspects, the amount of a linalol formulation present in the laundry detergent composition is capable of reducing the amount of static electricity generated when compared to a laundry detergent composition that does not include a linalol formulation or one that includes an essential oil comprising less than 30% linalol. In other aspects, the amount of linalol present in the laundry detergent composition is effective to reduce the generated static electricity by greater than 42% as compared to a laundry detergent composition that does not include a linalol formulation or a laundry detergent that includes an essential oil comprising linalol as a fragrance agent when tested using ASTM.

Not wishing to be bound by theory, the laundry detergent compositions that include a fragrance agent, such as an essential oil that includes linalol, do not provide an effective amount of linalol i.e., 30% or greater of linalol. In addition, the fragrance agents have been modified to reduce their evaporation rates during the washing cycle and such modifications may also play a role in why such fragrance agents are ineffective at conditioning fabrics, reducing soap residue, retaining color and reducing the amount of generated static electricity when compared to the laundry detergent compositions of this invention.

### Formulations

Effective amounts are generally those amounts listed as the ranges or levels of ingredients in the descriptions, which follow hereto. Unless otherwise stated, amounts listed in percentage (‘%’s″) are in weight percent.

In certain aspects, the linalol provided in the present laundry detergent compositions may range from 0.004% to 0.012%. In certain aspects, the laundry detergent compositions include at least 0.004%, 0.005%, 0.006%, 0.007%, 0.008%, 0.009%, 0.01%, 0.011%, or 0.012% linalol. The laundry detergent compositions may include linalol itself and in certain aspects, the linalol may be a synthetic linalol.

In other aspects of the invention, the laundry detergent compositions may include an essential oil as a source of linalol. In these embodiments, the amount of the essential oil may range from 0.1% to 0.3%. In certain aspects, the effective concentration of an essential oil is at least 0.1%, 0.15%, 0.2%, 0.25%, or 0.3%. The laundry detergent formulations of the present invention include essential oils that provide at least 30-60% of linalol.

In certain instances, the amount of linalol or an essential oil in the laundry detergent compositions may be referred herein as an effective concentration. As known to one of skill in the art, the effective concentration is the recommended dose of the detergent multiplied by the weight percent of the ingredient in the detergent. As known to one of skill in the art, the recommended dose of the detergent is dependent upon the size of the washing machine in use.

In other aspects, the effective concentration of linalol in the laundry detergents may range from 0.008 to 0.015 grams. In certain instances, the effective concentration may be 0.008 g, 0.009 g, 0.01 g, 0.011 g, 0.012 g, 0.013 g, 0.014 g, or 0.015 g. In another aspect, the effective concentration of linalol may be 0.012 g. In certain aspects, the added linalol may be a natural linalol and in other aspects, the linalol may be a synthetic linalol.

The laundry detergent formulations of the present invention may have an effective concentration of an essential oil ranging from 0.02 to 0.05 grams. In certain instances, the effective concentration of an essential oil may be 0.02 g, 0.03 g, 0.04 g or 0.05 g. In one aspect, the effective concentration of the essential oil in the laundry detergent is 0.03 g.

As apparent to one of ordinary skill in the art, the laundry compositions may include a number of different sources of linalol as known to one of skill in the art. In certain aspects of the invention, the source of linalol may be from rosewood oil, bergamot oil or coriander oil. In another aspect, the source of linalol may be from lavender oil.

### Description of Additional Laundry Detergent Components

The laundry detergent compositions of the present invention not only include linalol but may comprise additional components which are known and conventional in laundry detergent products. In certain aspects, the laundry detergent compositions may include surface-active surfactants, builder substances, bleaching agents based on organic and/or inorganic peroxy compounds, bleaching activators, pH regulators, optical brighteners, graying inhibitors, and foam regulators.

The products according to the invention may contain one surfactant and in certain instances, two or more surfactants. Surfactants to be used in laundry compositions are well known in the art. Various surfactants may include anionic surfactants, nonionic surfactants, cationic surfactants, zwitterionic surfactants and amphoteric surfactants. Surfactants are organic chemicals that provide wetting, emulsifying and dispersing properties which enable the removal of dirt from fabrics. Examples of surfactants include, but are not limited to, nonioinic types such a fatty alcohol ethoxylates, nonylphenol ethoxlyates; anionic types such a sodium dodecylbenzene sulfonate and sodium lauryl sulfonate.

Additional examples of surfactants include alkyl benzene sulphonates, alkyl sulphonates, alkyl- and alkyl ether sulphates, primary alkyl sulphates, alkoxylated alcohols, alpha-sulphonates of fatty acids and of fatty acid esters, alkyl betaines, and alkyl polyglycosides all known in the detergent art. The amount of surfactant present in the subject compositions would be readily apparent to one of skill in the art. In certain aspects, the quantity of surfactant is at least 15%, but in certain instances may be at least 15%, 20%, 25%, 30%, 40%, 50%, 60%, 70%, 80%, 90% or 99% by weight of the composition. By the term “% by weight of the composition” is meant relative to the weight of all composition ingredients, including solvent etc.

In certain aspects, the present laundry detergent compositions may also include a builder, which is a material which functions to soften hard water by solubilization or other removal of polyvalent cations such as calcium and to a lesser extent magnesium salts responsible for water hardness compounds, e.g. soluble inorganic builders especially exemplified by sodium tripolyphosphate, sodium silicate and carbonates. Thus, builders are added to laundry detergent formulations to counter the detrimental effect of polyvalent cations on detergency, but they are also used to increase the efficiency and effectiveness of surfactants as detergents and to supplement their beneficial effects on soil removal. Soil dispersions are achieved by the builder decreasing the solubility of the surfactant in the bath, which promotes their adsorption onto substrate and soil particles. Builders are also used for alkalinity and buffering as high pH increases the negative potentials at soil substrate and promotes cleaning. Buffering is necessary to prevent soil and substrate components from lowering the pH, which results in lowering the surface potentials. The pH of the laundry detergent composition may be in the range of 7 to 12 and in certain instances range from 7 to 9. In certain aspects, the pH of the laundry detergent compositions may be 7, 8, 9, 10, 11, or 12.

Any builder known in the art may be present in the subject composition, for example, zeolites, sodium citrate, polyacrylate, sodium tripolyphosphate, EDTA, NTA, and sodium gluconate. The builder component of a laundry liquid is preferably present in the range from 7% to 50% but in certain instances may be at least 7%, 10%, 15%, 20%, 25%, 30%, 35%, 40%, 45%, or 50% by weight of the composition.

The detergent compositions of the present invention may further include one or more alkalinity sources to raise or control the pH. Alkalinity sources are known to one of skill in the art. Examples of alkalinity sources include, but are not limited to, sodium carbonate, sodium silicate, sodium hydroxide. In order to establish a desired pH value which is not automatically obtained by mixing the remaining components, the products according to the invention may contain acids which are compatible with the system and are environmentally compatible, in particular citric acid, acetic acid, tartaric acid, malic acid, lactic acid, glycolic acid, succinic acid, glutaric acid and/or adipic, acid, as well as mineral acids, in particular sulfuric acid, or bases, in particular ammonium or alkali metal hydroxides. Such pH regulators are present in the products according to the invention in quantities of preferably no more than 20 wt. %, but in certain instances may be at least 1%, 2%, 5%, 7%, 10%, 15%, 17%, or 20% by weight of the composition. In certain aspects, the laundry detergent compositions may include one or more bulking agents to dilute the detergent to a more useable concentration. Bulking agents for use in the subject compositions are known to one of skill in the art. Examples of bulking agents which may be used with the present compositions, include but are not limited to, neutral salts, such as sodium chloride or sodium sulfate.

In another aspect, the laundry detergent compositions may include one or more soil suspending agents to improve the rinsing characteristics. Soil suspending agents for use in the subject compositions are known to one of skill in the art. Examples of soil suspending agents which may be used with the present compositions include, but are not limited to, sodium carboxymethyl cellulose, and anionic polymers such as sodium polyacrylate.

The detergent compositions of the present invention may further include peroxy compounds such as organic peracids or peracid salts of organic acids. In certain aspects, the laundry compositions may include phthalimidopercaproic acid, perbenzoic acid or salts of diperdodecanedioic acid, hydrogen peroxide and inorganic salts which release hydrogen peroxide under washing conditions, which include perborate, percarbonate, persilicate and/or persulfate such as caroate. If a product according to the invention contains peroxy compounds, these are preferably present in quantities ranging from 1 to 30 wt. % but in certain instances may be at least 1%, 2%, 5%, 10%, 11%, 12%, 13%, 14% 15%, 20%, 25%, 27% or 30% by weight of the composition. In certain aspects, the laundry detergent compositions may include a bleaching agent stabilizer, such as for example phosphonates, borates or metaborates and metasilicates and magnesium salts such as magnesium sulfate.

Bleaching activators which may be used in the subject laundry compositions include compounds which, under perhydrolysis conditions, yield aliphatic peroxycarboxylic acids with preferably 1 to 10 C atoms, in particular 2 to 4 C atoms, and/or optionally substituted perbenzoic acid. Suitable substances are those which bear O- and/or N-acyl groups having the stated number of C atoms and/or optionally substituted benzoyl groups. Preferred substances are repeatedly acylated alkylenediamines, in particular tetraacetylethylenediamine (TAED), acylated triazine derivatives, in particular 1,5,-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate, 2,5-diacetoxy-2,5-dihydrofuran, enol esters, acetylated sorbitol and mannitol. Such bleaching activators may be present, in particular in the presence of the above-stated hydrogen peroxide-releasing bleaching agents, in a conventional quantity range, preferably in quantities of 1 wt. % to 50 wt. %, but in certain instances may be at least 1%, 1.5%, 2%, 2.5%, 5%, 10%, 15%, 20%, 25%, 30%, 35%, 40%, 45% or 50% by weight of the composition, relative to the entire product, but are preferably entirely absent when percarboxylic acid is used as the sole bleaching agent.

Graying inhibitors have the task of keeping dirt which has been dissolved away from the textile fiber suspended in the liquor. Water-soluble colloids of a mainly organic nature are suitable for this purpose, for example starch, size, gelatin, salts of ether carboxylic acids or ether sulfonic acids of starch or cellulose or salts of acidic sulfuric acid esters of cellulose or starch. Water-soluble polyamides containing acidic groups are also suitable for this purpose. Derivatives of starch other than those stated above, for example aldehyde starches, may further be used. Cellulose ethers, such as carboxymethylcellulose (Na salt), methylcellulose, hydroxyalkylcellulose and mixed ethers, such as methylhydroxyethylcellulose, methylhydroxypropylcellulose, methylcarboxymethylcellulose and mixtures thereof, are preferably used, for example in quantities of 0.1 to 5 wt. %, but in certain instances may be at least 0.1%, 0.2%, 0.3%, 0.5%, 0.75%, 1%, 1.5%, 2%, 2.5%, 3%, 4% or 5% by weight of the composition relative to the product.

The laundry detergent compositions according to the invention may contain derivatives of diaminostilbene disulfonic acid or the alkali metal salts thereof as optical brighteners, although they preferably contain no optical brighteners for use as a color washing product. Suitable compounds are, for example, salts of 4,4′-bis(2-anilino-4-morpholino-1,3,5-triazinyl-6-amino)stilbene 2,2′-disulfonic acid or compounds of similar structure which, instead of the morpholino group, bear a diethanolamino group, a methylamino group, an anilino group or a 2-methoxyethylamino group. Brighteners of the substituted diphenylstyryl type may furthermore be present, for example the alkali metal salts of 4,4′-bis(2-sulfostyryl)-diphenyl, 4,4′-bis(4-chloro-3-sulfostyryl)-diphenol, or 4-(4-chlorostyryl)-4′-(2-sulfostyryl)-diphenyl. Mixtures of the above-stated optical brighteners may also be used. The amount of brighteners in the laundry detergent compositions may range from 0.1 to 2 wt. %, but in certain instances may be at least 0.1%, 0.2%, 0.3%, 0.5%, 0.75%, 1%, 1.5%, or 2% by weight of the composition relative to the product.

The laundry detergent compositions of the present invention may further include foam inhibitors. Suitable foam inhibitors are, for example, soaps of natural or synthetic origin, which comprise an elevated proportion of C₁₈-C₂₄ fatty acids. Suitable non-surfactant foam inhibitors are, for example, organopolysiloxanes and mixtures thereof with microfine, optionally silanized silica as well as paraffins, waxes, microcrystalline waxes and mixtures thereof with silanized silica or bistearylethylenediamides. Mixtures of different foam inhibitors may also be used in the present laundry detergent compositions, for example, mixtures of silicones, paraffins or waxes. The foam inhibitors, in particular foam inhibitors containing silicone and/or paraffin, may be bound to a granular carrier substance which is soluble or dispersible in water. The amount of foam inhibitors in the laundry detergent compositions may range from 0.1 to 2 wt. %, but in certain instances may be at least 0.1%, 0.2%, 0.3%, 0.5%, 0.75%, 1%, 1.5%, or 2% by weight of the composition relative to the product.

The laundry detergent composition can be in any form, such as a solid, liquid, gel or any combination thereof. The composition may be in the form of a tablet or pouch, including multi-compartment pouches. The composition can be in the form of a free-flowing powder, such as an agglomerate, spray-dried powder, encapsulate, extrudate, needle, noodle, flake, or any combination thereof. However, the composition is preferably in the form of a liquid. Additionally, the composition may be in either isotropic or anisotropic form. In an optional variation, the laundry composition, or at least part thereof, may be in a lamellar phase.

Examples of laundry compositions according to the present invention are provided below. These compositions are provided as exemplary embodiments and are not to be construed as limiting examples. According to the present invention, an effective amount of linalol will be added to the following components in the range of 0.004% to 0.012%. In certain aspects, the laundry detergent compositions include at least 0.004%, 0.005%, 0.006%, 0.007%, 0.008%, 0.009%, 0.01%, 0.011%, or 0.012% linalol. The laundry detergent compositions may include linalol itself and in certain aspects, the linalol may be a synthetic linalol.

In other aspects of the invention, the laundry detergent compositions may include an essential oil comprising 30% or more of linalol. In these embodiments, the amount of the essential oil may range from 0.1% to 0.3%. In certain aspects, the effective concentration of an essential oil is at least 0.1%, 0.15%, 0.2%, 0.25%, or 0.3%.

As apparent to one of ordinary skill in the art, the laundry compositions may include a number of different essential oils that comprise linalol. In certain aspects of the invention, the essential oil comprising linalol may be from rosewood oil, bergamot oil or coriander oil. In another aspect, the essential oil comprising linalol may be lavender oil. The essential oils have not been formulated or modified to impart a fragrance but are included in the laundry detergent compositions to provide an effective amount of linalol.

It would be apparent to one of skill in the art that the following amounts will be adjusted depending on the amount of linalol included in the formulation.

1. Powder, Non-Phosphate Laundry Detergent

| | | |
|---|---|---|
| 53.9 | parts | Sodium Carbonate |
| 30 | parts | Sodium Metasilicate |
| 15 | parts | Nonionic Surfactant, Tomadol 600 ® |
| 1.0 | parts | Carboxymethylcellulose |
| 0.1 | parts | Optical dye Tinopal CBS ® |
| 0.1-3 | parts | Linalol |

2. Powdered, Non-Phosphate, Oxygen Bleach Laundry Detergent

| | | |
|---|---|---|
| 49 | parts | Sodium Carbonate |
| 20 | parts | Sodium Perborate monohydrate |
| 20 | parts | Sodium Metasilicate |
| 10 | parts | Nonionic surfactant Tomadol 600 ® |
| 1.0 | parts | Carboxymethylcellulose |
| 0.1-3 | parts | Linalol |

3. Powdered Phosphate Laundry Detergent

| | | |
|---|---|---|
| 30 | parts | Sodium Tripolyphosphate |
| 19 | parts | Sodium metasilicate |
| 35 | parts | Sodium Carbonate |
| 15 | parts | Nonionic Surfactant Tomadol 600 ® |
| 1.0 | parts | Carboxymethylcellulose |
| 0.1-3 | parts | Linalol |

4. Liquid Neutral pH Laundry Detergent

| | | |
|---|---|---|
| 55 | parts | Water |
| 15 | parts | Tomadol 900 ® |
| 25 | parts | SodiumXylenesulfonate 40% solution |
| 5.0 | parts | Sodium Citrate |
| 0.1-3 | parts | Linalol |

5. Liquid Alkaline pH Laundry Detergent

| | | |
|---|---|---|
| 42 | parts | Water |
| 20 | parts | Sodium Metalsilicate Pentahydrate |
| 10 | parts | Tomadol 900 ® |
| 25 | parts | Sodium Xylene sulfonate 40 percent |
| 3 | parts | Sodium Gluconate |
| 0.1-3 | parts | Linalol |

6. Two Part Liquid Product.

Parts are dosed independently into the wash solution

Part A

| | | |
|---|---|---|
| 70 | parts | Water |
| 30 | parts | Tomadol 900 ® |

Part B

| | | |
|---|---|---|
| 60 | parts | Water |
| 35 | parts | N Silicate (waterglass)) |
| 5.0 | parts | Sodium Gluconate |
| 0.1-3 | parts | Linalol |

7. Liquid Laundry Detergent

| | |
|---|---|
| 75.4 parts | de-ionized water |
| 10.0 parts | Glucopan 625UP ® |
| 10.0 parts | Tomadol 900 ® |
| 3.40 parts | BayPure CX100 liquid ® |
| 1.00 parts | Alcosperse 747 ® |
| .20 parts | essential oil (30% or more percent linalol) |

### Description of Laundry Process

The above laundry compositions may be employed in methods for fabric laundering. Aspects of the invention include methods of conditioning fabric by administering a laundry detergent. In certain aspects, the present invention includes methods of conditioning fabric which comprises administering a laundry composition which includes linalol and is able to condition the fabric during washing and improves the removal of detergent residue.

Commercial laundry utilizes a commercial laundry machine sized to meet specific production requirements. These range from 20 pound dry weight machines to those capable of several hundred pounds. The majority of these machines are front loading. They are general described as washer extractors as they incorporate high speed spin to extract water between cycles.

Examples of the washer extractors include but are not limited to Wascomat Super 140G force from Wascomat and Unimac model UW60TV from Unimac.

Many of the washing machines can be programmed to specific wash formulas of multiple prewash, wash, bleach and rinse cycles. Other machines come with fixed wash programs.

An exemplary wash program is proved below which is not to be construed as a limitation.

Cold water prewash 2-4 minutes

Drain

Wash cycle, hot water, 5-15 minutes

Drain

Bleach cycle, mixed hot/cold, 5-10 minutes

Drain, spin water extract

Rinse 1, cold, 3 minutes

Drain

Rinse 2, cold, 3 minutes

Drain

Rinse 3, hot, 3 minutes

Drain Spin water extract

The detergent and other wash chemicals are added by an integrated chemical dispenser operationally connected to the washer.

Aspects of the invention further include method for reducing soap residue on washed fabrics by adding an unscented laundry detergent composition comprising an effective amount of an essential oil comprising 30% or more of linalol to a washing machine loaded with fabrics. The washing machine is then run to wash the fabrics, wherein said washed fabrics are conditioned and have less detergent residue when compared to fabrics washed with a detergent without linalol or a detergent that includes an essential oil with less than 30% linalol.

This invention is further illustrated by the following examples which should not be construed as limiting. The contents of all references, patents and published patent applications cited throughout this application are hereby incorporated by reference. The following examples are put forth so as to provide those of ordinary skill in the art with a complete disclosure and description of how to make and use the present invention, and are not intended to limit the scope of what the inventors regard as their invention. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

### Example 1

### Preparation Methods for Powdered Detergents

The sodium Carbonate is added to a suitable mixer such as ribbon mixer and the mixer is started. The liquid Tomadol® is slowly added to the carbonate and mixer until incorporated. Next, 0.1% to 0.3% of an essential oil that includes greater than 30% linalol is added to the mixer. The remaining ingredients can be added in any order and then mixed until uniform. The product is packaged in a suitable container with a moisture barrier.

### Example 2

### Preparation methods for Liquid Detergents

The liquid detergents are mixer in a stainless steel mix tank with a suitable agitator which will create suitable mixing action. Water is first added to the mix tank and the agitation started. Next, 0.1% to 0.3% of an essential oil that includes greater than 30% of linalol is added to the mixer. The remaining ingredients can be slowly added in any order and mixed until a clear solution is created. The product is packaged in a suitable plastic container.

### Example 3

### Linalol Laundry Detergent Composition Improves Color Retention, Fabric Softening Qualities and Reduces Static Electricity

Test data indicates a combination of new and unexpected properties relating to the addition of a linalol formulation to a laundry detergent. These results demonstrate the improved fabric softness, color retention, and reduced static electricity associated with the addition of an essential oil having greater than 30% of linalol to a laundry detergent.

Fabric softness and color retention (lack of discoloration) are important attributes for a laundry detergent. A detergent in addition to cleaning must provide an overall effect including softening and color retention of fabric.

The flowing detergents were made to illustrate the effect of softness and color retention.

Product A with Linalol

| | |
|---|---|
| 75.4 percent | de-ionized water |
| 10.0 percent | Glucopan 625UP ® |
| 10.0 percent | Tomadol 900 ® |
| 3.40 percent | BayPure CX100 liquid ® |
| 1.00 percent | Alcosperse 747 ® |
| .20 percent | lavender oil (30% or greater percent linalol) |
| | (purchased from Orchidia Code #50-6155-01) |

Product B without Lavender Oil

| | |
|---|---|
| 75.60 percent | de-ionized water |
| 10.0 percent | Glucopan 625UP ® |
| 10.0 percent | Tomadol 900 ® |
| 3.40 percent | BayPure CX100 liquid ® |
| 1.00 percent | Alcosperse 747 ® |

These products were mixed in 1000 gram batches in a glass beaker using a mechanical stirrer. All raw materials were measured using an electronic balance and total batch sizes were confirmed to be within 3 grams of total of 1000 grams.

Tomadol 900® is product of Air Products, USA

Glucopan 625® Up is product of Cognis chemical

BayPure CX100® is product of Bayer chemical

Alcosperse 747® is product of Alco chemical

These products were identical in all respects with the exception of the linalol in Product A.

These two products were tested using ASTM D-5237-05 which is a five cycle washing test with a detergent dose of 0.50 liquid ounces per wash cycle. No other chemicals were used in the wash test.

The results for softness and color retention were as follows:

| Product | Softness | Color retention |
|---|---|---|
| A | 4.30 | 5.0 |
| B | 3.7 | 4.7 |

These results are measured on a 0-5 scale with 5 being the best outcome. The effective concentration of lavender oil in the laundry detergent was 0.03 grams. The effective concentration of linalol was 0.012 grams per wash cycle.

As demonstrated from the data above, the washed bundle of laundry items washed with the detergent that comprised 30% or more linalol demonstrated greater softening and color retention characteristics.

In addition, the washed bundle washed with linalol showed a 42% reduction in generated static electricity when compared to the wash bundle washed in the detergent without linalol.

### Example 4

### Linalol Laundry Detergent Composition Improves Color Retention, Fabric Softening Qualities and Reduces Static Electricity

Test data demonstrates that linalol formulations provide superior softness to a detergent which is not associated with the use of a linalol fragrance in a laundry detergent. The linalol in these tests are provided as lavender oil. (Lavender oil purchased from Orchidia Code #50-6155-01)

Vaska Unscented detergent and four competitive detergents were testing in a 5 cycle bundle test per ASTMD5237-92. The Vaska Unscented detergent includes lavender oil comprising 30% or more of linalol. The performance attribute that was evaluated was fabric softness.

In all cases the detergent was used at dose level of 0.75 fluid ounces per wash cycle.

The evaluation of fabric softness was completed per ASTM D5237-92 using a 5 point scale with a value of 5 being rated as very soft, 4 rated as soft, 3 as slightly soft, 2 as slightly harsh and 1 as harsh.

Competitive products “A”, “B” and “C” contained a lavender oil fragrance and Competitive product “D” contained no fragrance and served as a control.

The following results were completed using and independent test laboratory qualified to complete the ASTM D5237-92 test.

| Product | Softness Rating |
|---|---|
| Laundry detergent with lavender oil (with greater | 4.2 |
| than 30% linalol | |
| Competitive Product A (lavender fragrance) | 3.8 |
| Competitive Product B (lavender fragrance | 3.8 |
| Competitive Product C (lavender fragrance) | 3.5 |
| Competitive Product D (no fragrance and no linalol) | 4.0 |

Fabric Softener 5 Cycle Bundle Test-Shuster Test Method PS-187B and ASTM D5237-92 Standard Guide For Evaluating Fabric Softeners. Performance Properties: 5 Cycle Bundle Test, 100° F. Water Temperature/150 ppm Water Hardness, 7 Lbs. Laundry Bundles (Towels/Half Sheets) Washed With Test Samples and Dried.

As demonstrated from the data above, the washed bundle of laundry items washed with the detergent comprising 30% or more of linalol, which was not formulated as a fragrance agent, demonstrated greater softening characteristics when compared to detergents that included linalol as a fragrance.

1) An unscented laundry detergent composition comprising an effective amount of an essential oil comprising 30% or more of linalol, wherein the essential oil does not function to impart a fragrance to the laundry and wherein the linalol is in an amount effective for conditioning a fabric during a washing program.

2) The laundry detergent composition according to claim 1, wherein the effective amount of the essential oil ranges from 0.1 to 0.3 weight %.

3) The laundry detergent composition according to claim 2, wherein the effective amount of the essential oil is 0.2 weight %.

4) The laundry detergent composition according to claim 1, wherein the essential oil is lavender oil.

5) The laundry detergent composition according to claim 4, wherein the lavender oil has an effective concentration ranging from 0.01 to 0.05 g.

6) The laundry detergent composition according to claim 5, wherein the lavender oil has an effective concentration of 0.03 g.

7) The laundry detergent composition according to claim 1, wherein the washed fabrics are softer than fabrics washed with a detergent without linalol or a detergent that includes an essential oil comprising less than 30% linalol.

8) The laundry detergent composition according to claim 1, wherein the detergent composition reduces soap residue on washed fabrics as compared to fabrics washed with a detergent without linalol or a detergent that includes an essential oil comprising less than 30% linalol.

9) The laundry detergent composition according to claim 1, wherein the detergent composition improves color retention of washed fabrics as compared to fabrics washed with a detergent without linalol or a detergent that includes an essential oil comprising less than 30% linalol.

10) The laundry detergent composition according to claim 1, wherein the detergent composition reduces static electricity in washed fabrics as compared to fabrics washed with a detergent without linalol or a detergent that includes an essential oil comprising less than 30% linalol.

11) The laundry detergent composition according to claim 1, wherein the detergent is a powder detergent.

12) The laundry detergent composition according to claim 1, wherein the detergent is a liquid detergent.

13) The laundry detergent composition according to claim 1, wherein the essential oil has not been deposited on a carrier material, encapsulated or embedded in compounds to control its evaporation rate during a washing and drying process.

14) A method for reducing soap residue on washed fabrics comprising:
a) adding an unscented laundry detergent composition comprising an effective amount of an essential oil comprising 30% or more of linalol to fabrics; and
b) washing the fabrics, wherein said washed fabrics are conditioned and have less detergent residue when compared to fabrics washed with a detergent without linalol or a detergent that includes an essential oil comprising less than 30% linalol.

15) The method according to claim 14, wherein the effective amount of the essential oil ranges from 0.1 to 0.3 weight %.

16) The method according to claim 15, wherein the effective amount of the essential oil is 0.2 weight %.

17) The method according to claim 14, wherein the essential oil is lavender oil.

18) The method according to claim 17, wherein the lavender oil has an effective concentration ranging from 0.01 to 0.05 g.

19) The method according to claim 18, wherein the lavender oil has an effective concentration of 0.03 g.

20) The method according to claim 13, wherein the washed fabrics are softer than fabrics washed with a detergent without linalol or a detergent that includes that includes an essential oil comprising less than 30% linalol.

21) The method according to claim 13, wherein the fabrics have improved color retention as compared to fabrics washed with a detergent without linalol or a detergent that includes that includes an essential oil comprising less than 30% linalol.

22) The method according to claim 13, wherein the fabrics have reduced static electricity as compared to fabrics washed with a detergent without linalol or a detergent that includes that includes an essential oil comprising less than 30% linalol.

23) An unscented laundry detergent composition comprising an effective amount of linalol ranging from 0.004% to 0.012%, wherein the linalol is effective in conditioning a fabric during a washing program.

24) The laundry detergent composition according to claim 23, wherein the linalol is a synthetic linalol.
